(19) United States
(12) Patent Application Publication
(10) Pub. No.: US 2009/0327120 A1
(43) Pub. Date: Dec. 31, 2009

(54) Tagged Credit Profile System for Credit Applicants

(76) Inventors: Ike O. Eze, Oakland, CA (US); Tuyen N. Vo, Oakland, CA (US)

Correspondence Address: COURTNEY STANIFORD & GREGORY LLP, 10001 N. De Anza Blvd., Suite 300, Cupertino, CA, 95014, US

(21) Appl. No.: 12/491,134

(22) Filed: Jun. 24, 2009

Related U.S. Application Data
(60) Provisional application No. 61/076,243, filed on Jun. 27, 2008.

(51) Int. Cl. G06Q 40/00; G06F 17/30

(52) U.S. Cl. 705/38; 705/35; 707/5; 707/E17.109

(57) ABSTRACT

Embodiments of user profile tagging process for an online credit application system are described. The process stores keywords represented as tags relating to various characteristics of the user. These characteristics can include objective information regarding the user, and subjective information, such as user preferences, background, affiliations, behavior patterns, and so on. A query function allows a querying user to input query tags to determine an aggregate or mean credit score for users who have certain characteristics. In response to a user query, the system identifies all other users that match the query tags entered by the querying user. The system calculates the aggregate credit score for these other users and displays this aggregate score relative to the credit score of the querying user.

### CROSS-REFERENCE TO RELATED APPLICATIONS

The present application claims the benefit of the U.S. Provisional Application No. 61/076,243 entitled “Tagged Credit Profile System for Credit Applicants,” and filed on Jun. 27, 2008.

### FIELD

Embodiments of the invention relate generally to electronic commerce systems, and more specifically to rating comparison systems for credit applicants.

### BACKGROUND

Many different loan products and credit cards are available to borrowers through online vendors. The most important factor in a person's ability to obtain loans or credit cards at favorable rates and terms is the person's credit score. A credit score generally reflects a person's creditworthiness and is expressed as a number that represents a risk level to a lender. The higher the credit score, the more creditworthy a person is, and a high credit score generally allows a person to borrow money at better rates and under better terms. Financial institutions typically offer many different loan or credit products to consumers depending upon the financial profile of the borrowers. Under present loan application systems, a borrower must typically shop for a loan by making inquiries to the different financial institutions or shop through loan brokers. Such a process is typically very time consuming and often does not give the borrower a complete picture of what is available. With the advent of web-based processes, online systems for shopping for loans have become available. These systems, however, typically provide only a general selection of loan products that are available and not an accurate selection of products based on the qualifications of the borrower. Moreover, such systems may require that the lender or broker pull the borrower's credit report. If a person uses such a system to shop among a variety of different products, this can adversely affect the person's credit rating since multiple credit report pulls can lower the person's credit rating.

Present online loan application systems generally do not allow a user to investigate how he or she compares with other borrowers of similar backgrounds or interests with respect to credit rating and/or loan products of interest. A user only has an estimated credit rating (e.g., poor, fair, good, excellent), which only gives an indication of relative credit worthiness compared to the general population.

What is needed, therefore, is an online process that allows a user to compare his or her credit profile against that of other users in a meaningful and comprehensive manner.

What is further needed is an online process that allows a user to define profile characteristics that allows comparison of credit scores or ratings with users having similar profile characteristics.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a block diagram of a computer network system that implements embodiments of an online credit application system;

FIG. 2 illustrates a user profile entry for use in a tagged user profile system for an online loan application system, under an embodiment.

FIG. 3 illustrates a tag database for use in a tagged user profile system, under an embodiment.

FIG. 4 illustrates an example graphical user interface for a tag query and result output for a tagged user profile system, under an embodiment.

FIG. 5 illustrates an example of a tag cloud for use by a tagging user profile generator, under an embodiment.

### DETAILED DESCRIPTION

Embodiments of user profile tagging process for an online credit application system are described. The process stores keywords represented as tags relating to various characteristics of the user. These characteristics can include objective information regarding the user, and subjective information, such as user preferences, background, affiliations, behavior patterns, and so on. A query function allows a user to input query tags to determine an aggregate or mean credit score for users who have certain characteristics. In response to a user query, the system identifies all other users that match the query tags entered by the querying user. The system calculates the aggregate credit score for these other users and displays this aggregate score relative to the credit score of the querying user.

Embodiments can be used in conjunction with any type of credit application system that provides a basis for a group of users to have their credit information pulled from an established credit bureau. This could be any type of online credit or loan application system, or similar financial services system. The application system can provide objective and/or subjective information regarding a user's credit score. The user credit score information comprises a user's characterization of their own credit score. The system can be configured to obtain the credit score for the user if the user does not provide the credit score in response to the solicitation.

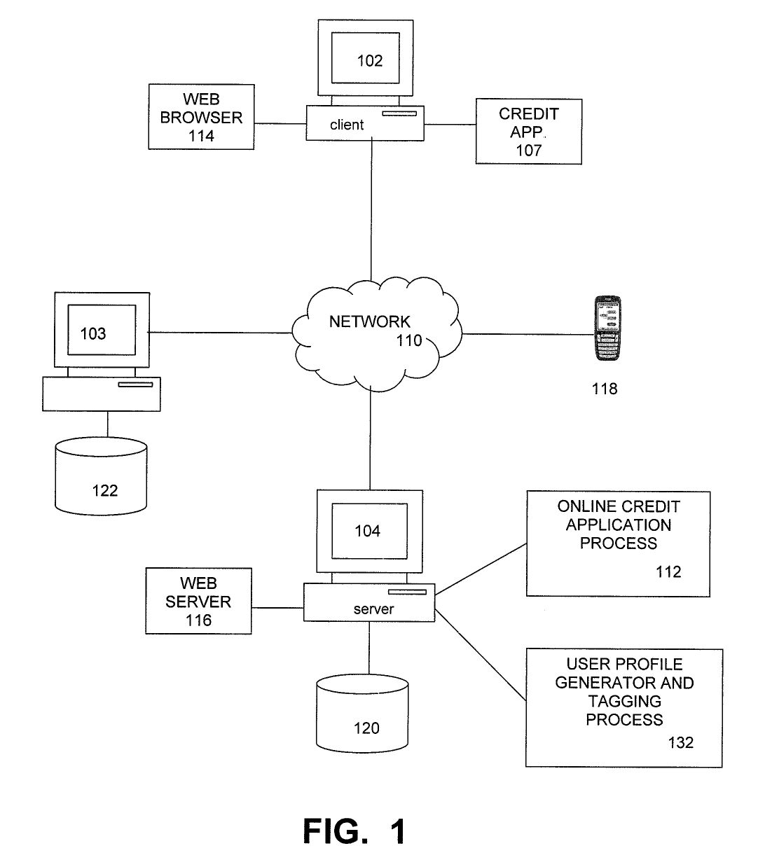

Embodiments of a tagged credit profile system for online credit application systems are described. Aspects of the one or more embodiments described herein may be implemented on one or more computers executing software instructions. The computers may be networked in a client-server arrangement or similar distributed computer network. FIG. 1 illustrates a computer network system 100 that implements one or more embodiments. In system 100, a network server computer 104 is coupled, directly or indirectly, to one or more network client computers 102 through a network 110. The network interface between server computer 104 and client computer 102 may include one or more routers that serve to buffer and route the data transmitted between the server and client computers. Network 110 may be the Internet, a Wide Area Network (WAN), a Local Area Network (LAN), or any combination thereof.

In one embodiment, the server computer 104 is a World-Wide Web (WWW) server that stores data in the form of web pages and transmits these pages as Hypertext Markup Language (HTML) files over the Internet 110 to the client computer 102. For this embodiment, the client computer 102 typically runs a web browser program 114 to access the web pages served by server computer 104 and any available content provider or supplemental server 103.

In one embodiment, server 104 in network system 100 is a server that executes a server side online credit application process 112. Client versions of this process 107 may also be executed on the client computers. This process may represent one or more executable programs modules that are stored within network server 104 and executed locally within the server. Alternatively, however, it may be stored on a remote storage or processing device coupled to server 104 or network 110 and accessed by server 104 to be locally executed. In a further alternative embodiment, the online credit application process 112 may be implemented in a plurality of different program modules, each of which may be executed by two or more distributed server computers coupled to each other, or to network 110 separately.

For an embodiment in which network 110 is the Internet, network server 104 executes a web server process 116 to provide HTML documents, typically in the form of web pages, to client computers coupled to the network. To access the HTML files provided by server 104, client computer 102 executes a web browser process 114 that accesses web pages available on server 104 and other Internet server sites, such as content provider 103 (which may also be a network server executing a web server process). The client computer 102 may access the Internet 110 through an Internet Service Provider (ISP). Data for any of the loan products, credit card products, debt products, user information, and the like may be provided by a data store 120 closely or loosely coupled to any of the server 104 and/or client 102. In one embodiment, the client computer may execute a client side credit application program 107 to interact with the server-side online credit application process 112. A separate content provider 103 may provide some of the data that is included in the product offering or application process.

The client computer 102 may be a workstation computer or it may be a computing device such as a notebook computer, personal digital assistant, or the like. The client computer may also be embodied within a mobile communication device 118, game console, media playback unit, or similar computing device that provides access to the Internet network 110 and a sufficient degree of user input and processing capability to execute or access the client-side credit application program 107. The client computers 102 and 118 may be coupled to the server computer 104 over a wired connection, a wireless connection or any combination thereof.

In one embodiment an online credit application system 112 facilitates the loan selection and application process through the display of loan application interfaces to a user. This process represents any type of application or platform through which a user requests credit information. For example, the online credit application system 112 may be a loan application platform that searches for available loans for the user based on certain profile information, such as preferences, profile, credit score, and so on. In this case, the user gives the system administrator permission to pull credit score information for the user from one or more credit bureaus.

Process 112 typically receives the user's consumer report on the user's behalf in response to some sort of request by the user (e.g., a loan application or a credit score request). In one embodiment, the process 112 may attempt to pull the score in a manner that attempts to ensure that the user's credit score is not impacted. In general, the more frequent a user's credit score is accessed, the greater the likelihood that the credit score will be reduced. This is due to certain access practices imposed by services that provide credit score and credit reporting information. A so-called “soft” or “below-the-line” inquiry constitutes a credit report pull that does not negatively impact the user's credit score. In certain circumstances, a soft inquiry is not possible or practical, and a credit bureau or similar organization must be used to obtain the credit report information. Such a credit report is typically maintained and made available by credit bureaus such as Equifax™, Experian™, or Transunion™.

Once the credit report is obtained, the relevant credit data and score are parsed out. This information is passed on to the user, and may also be stored locally, such as on data store 120, or in any other data store. In the case of a credit application process, this information can also be used to determine which loan products the user is qualified to apply for, or has the best chance in getting. Depending upon a user's credit score, the number of loan products may vary. In general, fewer loan products are available to users with lower credit scores, and such loan products tend to be more expensive (in terms of interest rate or fees) or restrictive.

In many cases, not only does a credit score inquiry potentially affect the user's credit score, such a process could also be relatively expensive, as credit bureaus and credit reporting services may charge a not insignificant amount of money per credit pull. In an alternative of process 112, the user does not provide or receive an actual credit score, but rather a qualitative measure or range of his or her credit worthiness. In this case, a credit grade or credit rating may be used to characterize a user's credit standing. In this case, the user may provide a qualitative measure or characterization of his or her credit score. Such a characterization could be a selection from the range POOR-FAIR-GOOD-EXCELLENT; it could be a letter grade, e.g., A-F, or a numeric value, e.g., 1-10, and so on.

Embodiments of the user profile generator system of FIG. 1 may be used by users during the course of applying for various types of loan or credit products, such as residential, consumer or mortgage loans, credit cards, rotating lines of credit, and the like. Such users can compare their credit background with those of other users.

### Tagged User Profile System

In one embodiment, system 100 includes a tagged user profile system that provides a basis for users to define particular characteristics associated with themselves and compare their credit scores or ratings with other users with similar or identical characteristics. This allows the user to see how he or she compares, credit-wise with people of similar backgrounds or interests.

As shown in FIG. 1, server 104 executes a user profile generator and tagging process 132 that allows a user to define certain characteristics, interests, preferences, background information, or any other relevant data that the user regards as of interest regarding himself or herself. This data is stored by server 104 as part of the profile information associated with the user. The user defines keywords and enters them through the graphic user interface of the online credit application process server. The keywords are tags that serve to define certain characteristics of the user and that can be used for searching by other users. These tags are stored in the user profile record that also includes information from the server 104 and one or more of the credit bureaus, agencies or financial institutions that provide information to the server regarding the user.

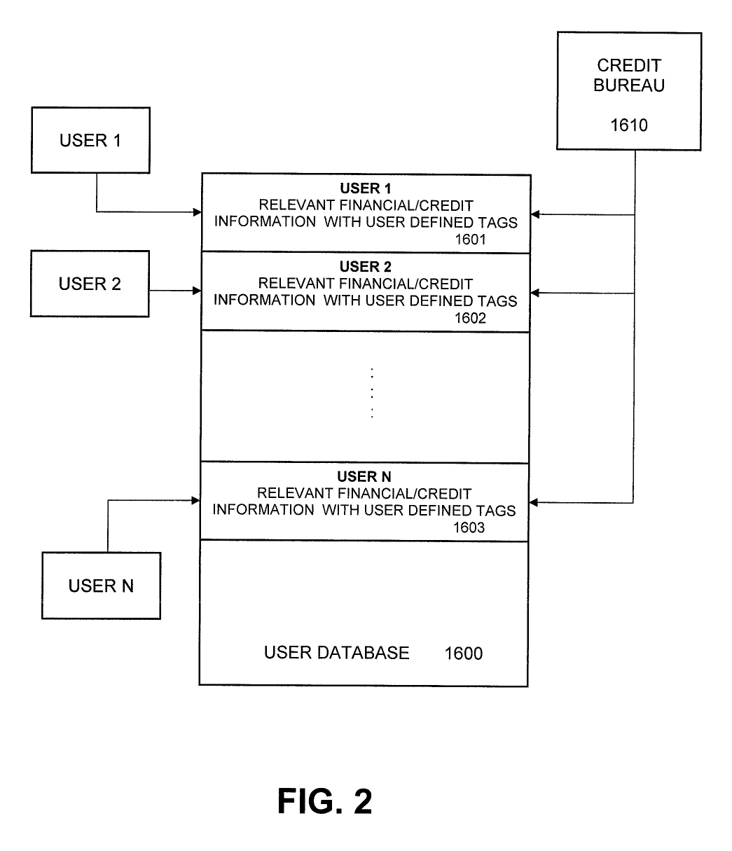

FIG. 2 illustrates a user profile entry for use in a tagged user profile system for an online loan application system, under an embodiment. As shown in FIG. 2, database 1600 maintained by server 104 stores user information for each user within the system. The database entries include information provided by one or more credit bureaus 1610 or other financial institutions, as well as information that may be provided by the server 104 itself. Each user also provides information directly to the database, thus for the example of FIG. 2, user 1 adds information to his or her respective database entry 1601, user 2 adds information to database entry 1602, and so on for each of the N users in the system.

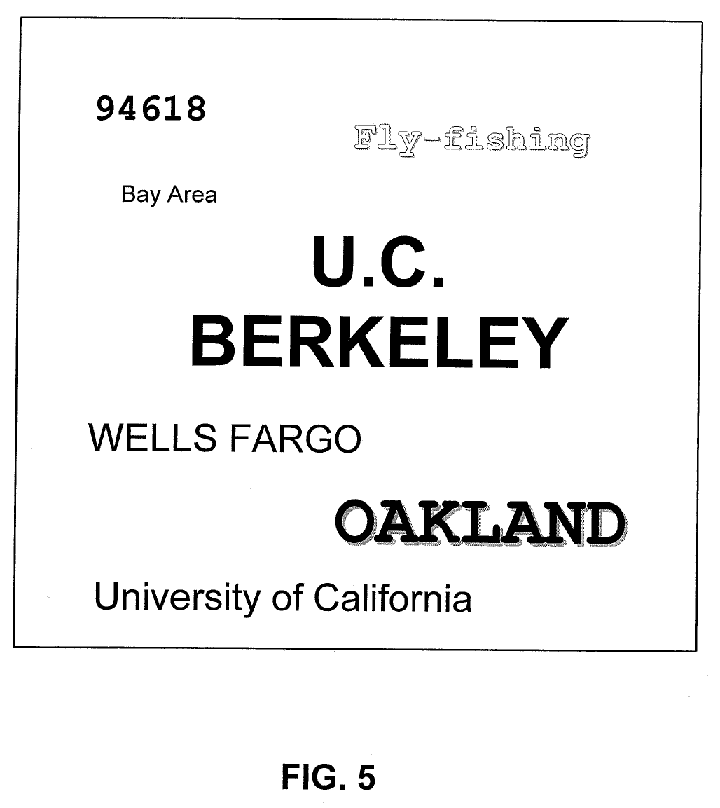

In one embodiment, the user entries comprise tags that consist of single keywords that are defined by the user in a certain order of relevance. In one embodiment, each user profile can be provided through a graphical user interface that displays the tags as visual tag clouds. A tag cloud is a set of related tags with corresponding weights, and can be a visually presented weighted list of user-generated keywords to describe various aspects of the user. In one embodiment, the tag cloud may be some kind of list or database of single-word tags or tag phrases, which may be listed alphabetically or by priority. Alternatively, the tag cloud may be shown to the user as a random display of tag words or phrases with the importance of a tag is shown with font size or color. Thus, finding a tag by both alphabetical order and by popularity is possible. FIG. 5 illustrates an example of a tag cloud for use by a tagging user profile generator, under an embodiment. Typical tag clouds may have between 10 and 50 tags, and the relative weights are represented using font sizes, colors, font effects, display location, or other visual clues, as shown in FIG. 5. In one embodiment, the tag clouds can be interactive, in that the tags are hyperlinks that allow an accessing user to access web pages or other resources that are associated with the tag. FIG. 5 is an example of one type of user interface presentation of tag information as provided by the user, and many other graphical representations are possible.

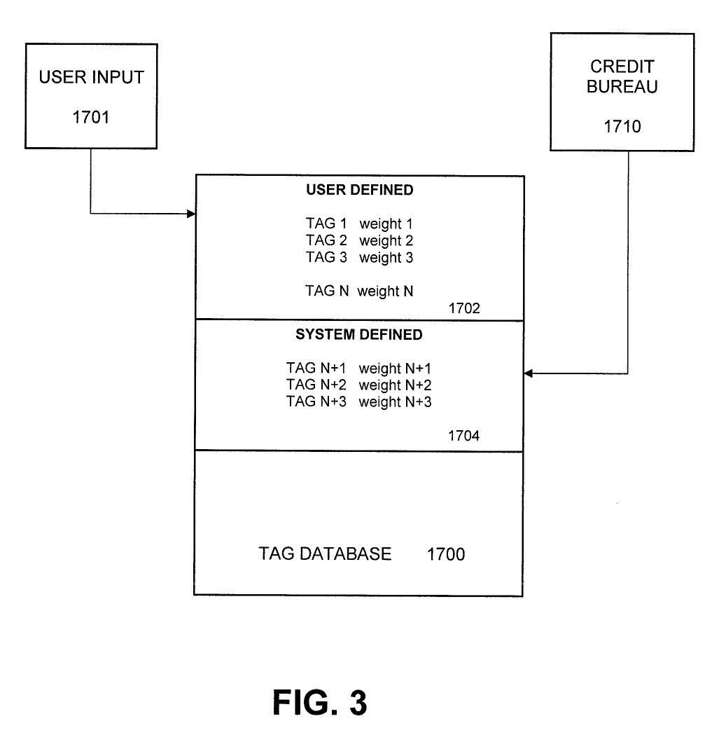

The tags for each user are stored in a tag database maintained by the server 104. The tag database can be a separate database in which all tags are stored and indexed by user, or it can represent the tag fields for each user profile entry that can be accessed by the server. FIG. 3 illustrates a tag database for use in a tagged user profile system, under an embodiment. The tag database 1700 includes a number of tag keywords along with the weight or priority associated with the tag. Tags that are directly provided by user input 1701 are stored as user-defined tags 1702. For the example shown in FIG. 3, tags 1-N are defined, each with an associated weight. Any number of tags can be defined and stored in accordance in system (i.e., memory) constraints. In an embodiment, the tags are stored in the tag as simple ASCII text format. Depending on system constraints and requirements, the tags may be encoded or formatted in any suitable format, such as to facilitate data portability to other systems and/or applications.

In one embodiment, tags may also be provided by the system or other entity, such as the credit bureau or financial institution that provides other information stored in the user database 1600. These tags may be stored in the tag database as system-defined tags 1704. In one embodiment, the system-defined tags can be generated by the system based on certain business rules or intelligent processes that analyze user behavior or trends. These tags can then be suggested or recommended to the user through the system GUI. The user then has the choice and opportunity to add the recommended tags to the tag database, and assign a weight to the recommended tag. A user can define virtually any type of tag to insert into their respective tag database, such as location, school affiliation, occupation, age, gender, hobbies, club memberships, marital status, and so on.

The system-defined tags 1704 may be generated by a number of sources, such as business rules, or data available about the user from one or more third-party databases. The business rules can be defined to determine certain relevant aspects or behavioral characteristics of the users and automatically generate a tag to reflect that fact. For example, the system may define an age tag for a user based on the date of birth entered by the user in the database, and then suggest the user define a tag for the age or age range. Relevant information can also be provided by third-party databases. For example, the occurrence of a bankruptcy may be available in a credit reporting database, or the presence of a lien judgment against the user may be available in a court database. Similarly, the location of a user may be provided (at least to a rough approximation) by the user's ISP (Internet Service Provider). Thus, the occurrence of these events or factual characteristics may be captured by the appropriate tag, and suggested to the user, if the user has not input such a tag himself.

The system-defined tags can comprise a user's actual credit score. Alternatively, it can be a qualitative measure or range of his or her credit worthiness, such as a credit grade or credit rating that may be used to characterize a user's credit standing. Such a characterization could be a selection from the range POOR-FAIR-GOOD-EXCELLENT; it could be a letter grade, e.g., A-F, or a numeric value, e.g., 1-10, and so on. In an embodiment, this credit information (credit score or credit characterization) may be provided by a third party credit agency or rating service as a system-defined tag, or it may be provided by the user as a user-defined tag. The credit information in the database may be used as an index against which other information regarding all the users in the system may be pulled.

In an alternative embodiment, the system-defined tags can be automatically added to the tag database without user approval or even knowledge. This enables the system to build up a comprehensive tag profile for each user without requiring explicit user defined tags. It also ensures that tags are defined uniformly for certain key traits or occurrences for each user, such as gender, age, bankruptcies, and other possible critical facts regarding a user. The system may further be configured to automatically generate and suggest or add common synonyms for tags input by the user. For example, UC Berkeley is officially, known as University of California, Berkeley, but is popularly referred to as “Cal”, thus the system may add “Cal” and “University of California” if the user only inputs the tag “UC Berkeley.” This allows the system to return results if the querying user does not specify query keywords in the exact format as entered by the users.

In one embodiment, the tags defined for each user through user input and/or system generation can be used by each user to analyze the credit scores for users based on certain tagged characteristics. The user can then compare their own credit score against these other people to see where they stand credit-wise relative to a certain population. In one embodiment, the user profile generator and tagging process 132 includes a user interface component that allows a user to input a tag search to see how their score compares against people who have some or all of the tags specified by the user. For example, if the user is a resident of San Francisco, the user can compare their score with all other users who are tagged as residents of San Francisco, or residents of San Francisco who are between 30 and 40 years of age and attended UC Berkeley, and so on.

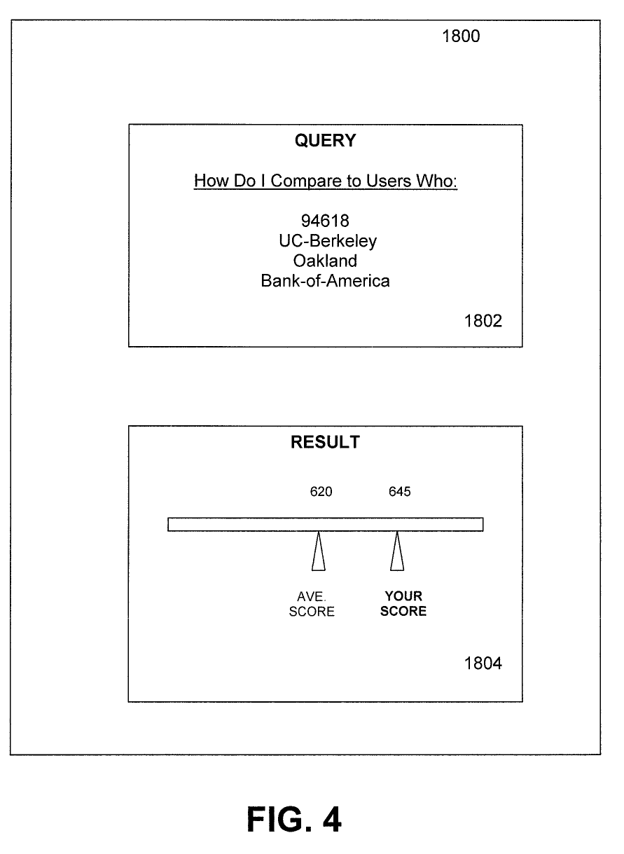

The result indicating the user's credit score or credit profile relative to other users found in the tag search can be presented in any suitable manner through the system GUI. For example a tabular result showing the user's credit score against the mean credit score for that group of user's can be provided in numerical form. Alternatively, a scaled output showing the user's score on a scale relative to the mean score can be provided. In a further alternative, a graphical result output can be provided in which all users in the defined tag group are shown as data points on a credit score distribution graph, and the user's score is also indicated as a point on the graph. FIG. 4 illustrates an example graphical user interface for a tag query and result output for a tagged user profile system, under an embodiment. As shown in FIG. 4, user interface page 1800 includes a query window 1802 that allows a user to input keywords to identify other users. Any number of keywords may be entered, but certain words or keyword combinations may not yield any appreciable number of users. The credit scores for all users with tags corresponding to the entered keyword or keywords are then returned by the system, and then tabulated or displayed in conjunction with the user's own credit score. The results are displayed in the display window 1804. For the embodiment of FIG. 4, the result is shown as a linear scale with the user's score shown in relation to the mean score for all users who had tags corresponding to 94618, UC Berkeley, Oakland, and Bank of America in their user profiles.

Instead of providing a comparison based on objective credit score data, the system can also provide a comparison based on subjective credit grade or credit rating data. Such objective data could be provided by the users themselves, or compiled by the credit bureaus or some other process, such as the online credit application process, that have some basis of knowledge of the users within the group of users.

In one embodiment, the system can be configured to return results only for users who matched all tags entered by the querying user. Alternatively, the system can be configured to provide results for partial matches based on less than all of the keywords. The system can also be configured to drop any queried keywords for which appreciable results are not available.

In one embodiment, the comparison result can be based on historical data to present a timeline result for the user. In this embodiment, the user's present credit score is shown in relation to a historical distribution of scores for users over a specified period of time.

In one embodiment, the tag database storing defined keywords for each user of the system can provide the basis of a social network system that allows users to interact with other users based on their tagged user profiles. For example, one or more user forums may be maintained or supported by the system to allow communities to be defined based on certain tags, such as all users who live in a particular city, or are alumni of a certain school, and so on. Such users can then interact to exchange information. The system can also be configured to automatically compile information relating not only to user credit scores, but products purchased by such users. Thus, a querying user can find out which loan products were most often obtained by certain classes of users. The system can further be configured to provide recommendations of products to the querying user based on the buying patterns of users in the group identified by the keyword query. For this embodiment, the tag data in the tag database may be exported to one or more other databases for use in market research or similar applications.

Embodiments of the tagged credit profile process for online loan application systems herein may be applied to various types of loan or credit products, such as residential, consumer or mortgage loans, credit cards, rotating lines of credit, and the like. In general, the application for any such loan or credit product requires the lender to obtain a copy the user's credit report. When a user requests a credit report, the user's credit rating may be adversely affected. In general, multiple credit report pulls results in the lowering of a user's credit rating. Embodiments of the present system allow user to compare their chance of success with regard to applying for loan against other people with similar backgrounds. This would give them an idea as to whether or not they should even apply for particular loan products or not. Thus, a system that allows a user to define certain profile characteristics through a tag cloud associated with the user and to compare himself or herself to other users with similar characteristics provides a basis for which users can gain a better insight into their credit worthiness without actually applying for a loan product or requesting a formal credit pull from a bureau.

Embodiments disclosed herein describe a method comprising: storing a plurality of keywords as tags for respective users of an online loan application system in a keyword database searchable by a query process, wherein each keyword of the plurality of keywords representing a characteristic associated with each respective user; receiving a keyword query from a querying user, the keyword query comprising one or more query tags; identifying users of the online loan application system matching the keyword query; calculating an aggregate credit score for the identified users; and displaying the aggregate credit score, credit rating, or credit grade of the identified users relative to the credit score of the querying user.

In this method, the characteristic associated with each respective user is selected from the group consisting essentially of: objective user profile information, subjective user profile information, user preference information, user behavior, user buying patterns, and significant user financial events.

The method may further comprise receiving at least some of the plurality of keywords directly from the user through a graphical user interface input process.

The method may further comprise receiving at least some of the plurality of keywords directly from a third party credit agency.

In this method, the keywords may be weighted with regard to significance.

In this method, the objective user profile information may consist of name, address, gender, date of birth, or social security number, and wherein the subjective user profile information includes at least one of: personal hobbies, affiliations, buying preferences, and educational background. The credit score comprises one of an objective credit score provided by a credit bureau, or a descriptive characterization user credit-worthiness selected from a range of possible characterizations.

This method may be used to facilitate the gathering of comparative credit score information for the purchase of a loan product from an online vendor. The method can be used to apply for a loan product that may be, but is not limited to, a home loan, auto loan, or credit card.

Embodiments may be implemented in a processing system comprising one or more separate processors or processor cores, or other processing components that may implement the user profile generator and tagging process 132 of FIG. 1. Such a system may comprise a first processor for storing a plurality of keywords as tags for respective users of an online loan application system in a keyword database searchable by a query process, wherein each keyword of the plurality of keywords representing a characteristic associated with each respective user, an input component for receiving a keyword query from a querying user, the keyword query comprising one or more query tags; a second processor coupled to the first processor for identifying users of the online loan application system matching the keyword query; a calculator component for calculating an aggregate credit score for the identified users; and a display device for displaying the aggregate credit score, credit rating, or credit grade of the identified users relative to the credit score of the querying user.

The system may be used to create a tagged database for applicants, wherein the database is created by the system receiving objective user profile information (that includes at least one of user address, gender, date of birth, or social security number), receiving user-defined keywords specifying user characteristics, and receiving system-defined data from a third party credit bureau. The database stores the user defined keywords and a hierarchical tag weight that is assigned to each user-defined keyword to rank each user-defined keyword among all of the user-defined keywords, as well as each system-defined data element and an assigned hierarchical tag weight that ranks each system-defined data element among all of the system-defined data.

Aspects of the online loan and credit application and tagging system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects of the method include: microcontrollers with memory (such as EEPROM), embedded microprocessors, firmware, software, etc. Furthermore, aspects of the described method may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the online loan and credit application system is not intended to be exhaustive or to limit the embodiments to the precise form or instructions disclosed. While specific embodiments of, and examples for, the newsletter hosting and transmission system are described herein for illustrative purposes, various equivalent modifications are possible within the scope of the described embodiments, as those skilled in the relevant art will recognize.

The elements and acts of the various embodiments described above can be combined to provide further embodiments. These and other changes can be made to the online loan application system in light of the above detailed description.

In general, in any following claims, the terms used should not be construed to limit the described system to the specific embodiments disclosed in the specification and the claims, but should be construed to include all operations or processes that operate under the claims. Accordingly, the described system is not limited by the disclosure, but instead the scope of the recited method is to be determined entirely by the claims.

While certain aspects of the online loan application system may be presented in certain forms, the inventors contemplate the various aspects of the methodology in any number of forms. For example, while only one aspect of the system is recited as embodied in machine-readable medium, other aspects may likewise be embodied in machine-readable medium.

What is claimed is:

1. A method comprising:
storing a plurality of keywords as tags for respective users of an online loan application system in a keyword database searchable by a query process, wherein each keyword of the plurality of keywords representing a characteristic associated with each respective user;
receiving a keyword query from a querying user, the keyword query comprising one or more query tags;
identifying users of the online loan application system matching the keyword query;
calculating an aggregate credit score for the identified users; and
displaying the aggregate credit score, credit rating, or credit grade of the identified users relative to the credit score of the querying user.

2. The method of claim 1 wherein the characteristic associated with each respective user is selected from the group consisting essentially of: objective user profile information, subjective user profile information, user preference information, user behavior, user buying patterns, and significant user financial events.

3. The method of claim 2 further comprising receiving at least some of the plurality of keywords directly from the user through a graphical user interface input process.

4. The method of claim 2 further comprising receiving at least some of the plurality of keywords directly from a third party credit agency.

5. The method of claim 1 wherein the keywords are weighted with regard to significance.

6. The method of claim 5 wherein the objective user profile information includes at least one of user address, gender, date of birth, or social security number, and wherein the subjective user profile information includes at least one of: personal hobbies, affiliations, buying preferences, and educational background.

7. The method of claim 1 wherein the credit score comprises one of: an objective credit score provided by a credit bureau, and a descriptive characterization user credit-worthiness selected from a range of possible characterizations.

8. The method of claim 7 wherein the information for the identified users is used to facilitate the gathering of comparative credit score information for the purchase of a loan product from an online vendor.

9. The method of claim 8 wherein the online loan application system is used to apply for a loan, and wherein the loan is selected from the group comprising: home loans, auto loans, and credit cards.

10. A method of creating a tagged database for applicants of a loan product comprising:
receiving objective user profile information that includes at least one of user address, gender, date of birth, or social security number;
receiving user-defined keywords specifying user characteristics;
assigning a hierarchical tag weight to each user-defined keyword to rank each user-defined keyword among all of the user-defined keywords;
receiving system-defined data from a third party credit bureau; and
assigning a hierarchical tag weight to each system-defined data element to rank each system-defined data element among all of the system-defined data.

11. The method of claim 10 wherein the user characteristics are selected from the group consisting of: personal hobbies, affiliations, buying preferences, and educational background.

12. The method of claim 11 wherein system-defined data comprises one of: an objective credit score for the user, and a descriptive characterization user credit-worthiness selected from a range of possible characterizations.

13. The method of claim 12 wherein the system-defined data further comprises significant financial events associated with the user.

14. The method of claim 12 significant financial events associated with the user are selected from the group consisting of: payment defaults, negative credit ratings, and bankruptcy filings.

15. The method of claim 14 further comprising:
receiving a keyword query from a querying user, the keyword query comprising one or more query tags;
identifying users of an online loan application system accessing the loan product by matching the keyword query;
calculating an aggregate credit score for the identified users; and
displaying the aggregate credit score, credit rating, or credit grade of the identified users relative to the credit score of the querying user.

16. The method of claim 15 wherein the information for the identified users is used to facilitate the gathering of comparative credit score information for the purchase of the loan product from an online vendor.

17. The method of claim 16 wherein the loan product is selected from the group comprising: home loans, auto loans, and credit cards.

18. The method of claim 15 further comprising:
displaying the user-defined keywords in a tag cloud displayed a user client computer; and
altering a display characteristic of each keyword of the user-defined keywords based on a respective hierarchical tag weight, wherein the display characteristic is selected from the group consisting of: font size, color, effect, and display location.

19. A system for processing an online loan application, comprising:
a first processor for storing a plurality of keywords as tags for respective users of an online loan application system in a keyword database searchable by a query process, wherein each keyword of the plurality of keywords representing a characteristic associated with each respective user;
an input component coupled to the first processor for receiving a keyword query from a querying user, the keyword query comprising one or more query tags;
a second processor coupled to the first processor for identifying users of the online loan application system matching the keyword query; a calculator component for calculating an aggregate credit score for the identified users; and
and a display device for displaying the aggregate credit score, credit rating, or credit grade of the identified users relative to the credit score of the querying user.

20. The system of claim 20 further comprising a database component for creating a tagged database for loan applicants, wherein the database is created by the system receiving objective user profile information including at least one of user address, gender, date of birth, or social security number), receiving user-defined keywords specifying user characteristics, and receiving system-defined data from a third party credit bureau; and wherein the database stores the user defined keywords and a hierarchical tag weight that is assigned to each user-defined keyword to rank each user-defined keyword among all of the user-defined keywords, as well as each system-defined data element and an assigned hierarchical tag weight that ranks each system-defined data element among all of the system-defined data.
